(19) United States
(12) Patent Application Publication
(10) Pub. No.: US 2009/0009472 A1
(43) Pub. Date: Jan. 8, 2009

(54) Data Input Method and Apparatus for Pda Thereby

(76) Inventor: No-Soo Park, Daejeon-city (KR)

Correspondence Address: CANTOR COLBURN, LLP, 20 Church Street, 22nd Floor, Hartford, CT, 06103, US

(21) Appl. No.: 11/570,795

(22) PCT Filed: May 10, 2005
(86) PCT No.: PCT/KR2005/001366

§ 371 Date: Sep. 18, 2008

(30) Foreign Application Priority Data
Jun. 18, 2004 (KR) 1020040045643
Jul. 12, 2004 (KR) 102004054012

(51) Int. Cl. G06F 3/033; G09G 5/08

(52) U.S. Cl. 345/160; 345/184

(57) ABSTRACT

Disclosed herein is an invention which relates to a data input apparatus for a handheld terminal and a method thereof comprising a sliding panel including a panel of a certain shape and a plurality of input members arranged at regular intervals on a certain portion of the bottom face of the panel; and a frame having the same shape as the sliding panel, the frame including one or more sliding through-holes having a longer inner diameter than that of the sliding panel, resting on a plurality of input buttons contained in the handheld terminal or on a plurality of input points forming a screen output from a touch screen, and inputting a key value of a corresponding input point by aligning any one of the input buttons or the input points with any one of the input members, the alignment being established by inserting the sliding panel into the sliding through-hole and displacing in a sliding manner.

### TECHNICAL FIELD

The present invention relates to a data input apparatus for a handheld terminal and a method of inputting data into the handheld terminal. More specifically, the invention relates to a data input apparatus for a handheld terminal and a method of inputting data into the handheld terminal, in which the data input apparatus is rested on a touch pad formed in a handheld terminal such as a PDA and the like, and a sliding panel is displaced to a corresponding input key, thereby inputting corresponding data in a speedy and easy way.

### BACKGROUND ART

As is well known, a handheld terminal such as a cellular phone, a PDA (Personal Data Assistance), a palm-top computer, and the like, is provided with a touch screen, and the touch screen is on a trend to be miniaturized and thinned gradually according to continuous development of technology.

The screen size of the touch screen is embodied in a smaller size according to the downsizing trend described above, and thus, in the case where the input operation is performed by pressing input keys displayed on the screen using a finger, durability is remarkably dropped by contamination of the touch screen and impairment damaged by a nail. Therefore, data input or function selection must be performed by contacting a corresponding key (hereafter, referred to as a touch pen) using a separate sharp pin.

However, a separately provided touch pen may be easily lost, and generally only one touch pen is used when performing data input operation using the touch pen, so that data input operation cannot be performed fast and easily.

In addition, in the case of inputting data on a touch screen with a hand, the handheld terminal is held by the other hand, and thus a portion of the touch screen is hidden by the other hand, thereby making it hard to figure out the data input process, or contaminating the touch screen and causing malfunction by the contamination.

Therefore, the advent of a data input apparatus for a handheld terminal has been required for inputting data easily without being provided with a touch pen, inputting data fast and easily using both hands, holding a handheld terminal and inputting data at the same time, preventing contamination of the touch screen, and confirming easily whether the data is entered.

### DISCLOSURE OF INVENTION

The present invention has been made in order to solve the above problems occurring in the art, and it is an object of the invention to provide a data input apparatus for a handheld terminal and a method thereof, in which speedy and easy data input operation is accomplished using both hands.

Another object of invention is to provide an data input apparatus for a handheld terminal comprising a sliding panel including a plurality of input members and a brace prominence, and a frame including one or more sliding through-holes having a longer diameter than that of the sliding panel, thereby the data input apparatus being rested on a touch screen, aligning the sliding panel with a corresponding input key which composes a screen output on the touch screen, and performing a corresponding data input or function selection operation by a pressurizing action.

Another object of invention is to provide a data input apparatus for a handheld terminal, in which the sliding panel includes four input members so as to allow inputting maximum four data consecutively by one displacement action.

Another object of invention is to provide a data input apparatus for a handheld terminal, in which, according as a user purchases an additional software and installs it at the handheld terminal by himself/herself, or the software is already stored in the handheld terminal when the product is shipped, a corresponding data is entered only when a location aligning signal is entered by establishing a location contact point between a specific portion of the touch screen and the brace prominence and an input contact point is established by a pressurizing action on a corresponding input key and an input member, thereby input errors being prevented fundamentally.

Another object of invention is to provide a data input apparatus for a handheld terminal and a method thereof, which remarkably improves damage protection of the display, semi-permanent usability, and inputting accuracy by an electronic input system, minimizes input errors by applying an input member such as a joystick of a 4-way contact point type which is familiar to a user, and allows inputting various character information efficiently, fast, and correctly into a corresponding terminal.

Another object of invention is to provide a data input apparatus for a handheld terminal and a method thereof, in which, according as an input control means which is embodied by a microcomputer or software is installed in an external input device such as a PDA, a PC, or the like, a desired character data is entered and the initial mode for selecting an input key unit is also restored by passing through a step of selecting an input key unit by the operation of the input member and a step of selecting an input key which is provided at the selected input key unit.

Another object of invention is to provide a data input apparatus for a handheld terminal and a method thereof, in which various types of character information can be entered according to the change to a character/number/symbol/image/function selection mode, when a plurality of input members are provided and the input member establishes a simultaneous contact point with any one of a plurality of input contact points.

In order to accomplish the above object, according to one aspect of the invention, there is provided a data input apparatus for a handheld terminal comprising a sliding panel including a panel of a certain shape and a plurality of input members arranged at regular intervals on a certain portion of the bottom face of the panel; and a frame having the same shape as the sliding panel, the frame including one or more sliding through-holes having a longer inner diameter than that of the sliding panel, resting on a plurality of input buttons contained in the handheld terminal or on a plurality of input points forming a screen output from a touch screen, and inputting a key value of a corresponding input point by aligning any one of the input buttons or the input points with any one of the input members, the alignment being established by inserting the sliding panel into the sliding through-hole and displacing in a sliding manner.

In addition, the sliding panel is formed in a square shape, further includes a brace prominence protruding at the center portion of the bottom surface, and has the input members allocated by one at each corner respectively. The four input members are aligned with any one of the four input points among the sixteen input points, the four input points being located at the place where the sliding panel is displaced inside the sliding through-hole according to four displacement methods of each corner, so that the key value of a corresponding input point is entered.

In addition, the handheld terminal of the invention further comprises one or more from: a guide panel including a location contact point through-hole and one or more input through-holes, wherein a portion of the surface corresponding to the brace prominence and a plurality of the input members pass through thereof according to the displacement of the sliding panel, and covers the bottom surface of the sliding through-hole; one or more detachment preventing latches, the latch being the top surface of the frame neighboring with the sliding through-hole extended to the direction of the sliding through-hole in a certain shape; and a coupler coupling the handheld terminal to both sides of the frame.

In addition, the handheld terminal of the invention further comprises an elastic member including a point end, the elastic member being provided on the surface neighboring with the input member; and a location alignment depression formed of one or more depressions, thereby the point end being latched and supported while an input member of the sliding panel is aligned with a corresponding input point.

In addition, the touch screen of the invention is configured such that, while the sliding panel is displaced and the input point is aligned with the input member, a location contact point is provided at each portion of the surface corresponding to the brace prominence, and only when the brace prominence and the location contact point establish a contacting point, the corresponding key value of the desired input point is entered.

In addition, the data input apparatus further comprising an input control means, in which, in the data input apparatus including a plurality of input contact points, an input means having one or more input members selected from an input lever or an input button, the input lever or the input button establishing a contact point with the input contact point, and a terminal having a display unit, a communication port, and character data such as character/symbol/image/number information, the input control means includes a screen output module loaded in the terminal or the input means for outputting a plurality of input key units in a divided form respectively through the display unit, the input key unit containing a plurality of input keys; an input key unit selection module for selecting a corresponding input key unit when an input member re-establishes a contact point with any one of the input contact points; and an input module for retrieving the corresponding key value of the input key from the character data and outputting on the screen through the display unit, when the input member re-establishes a contact point with any one of the input contact points again, and, at the same time, changing to the initial mode for selecting the input unit.

In addition, the input control means of the invention changes the mode from a character transition mode/enter key/function mode/selection mode to one or more modes, when a plurality of the input members establishes a simultaneous contacting point.

In addition, in the method of inputting data of the invention, the sliding panel provided with four input members is displaced to four directions of each corner, and any one of the four input members contained in the sliding panel is aligned with a corresponding input point of the input button or the touch screen, and thus the key value of the aligned input point is entered.

In addition, in the present invention, the sliding panel is displaced and a corresponding input point is aligned with any one of the four input members, and a brace prominence protruded on the bottom surface of the sliding panel and a location contact point which confirms the location of the sliding panel establish a contact point each other, and thus the key value of the corresponding input point is entered.

In addition, the present invention comprises steps of: i) selecting an input key unit containing a desired input key value to be entered from a plurality of input key units by manipulating the input member of the input means, the input key unit containing a division value and a plurality of input keys; and ii) inputting the desired input key value by re-manipulating the input member and selecting one input key from a plurality of the input keys which have the same division value.

Also, in the present invention, four input key units are formed, in which each input key has a division value of one of four divisions, so that 4×4 number of input keys are provided.

In addition, in the present invention, when inputting a division value through the input member at the same time or within a certain time period, a key value of a function mode is entered.

In addition, a division value to be described below is a unique code assigned to each of a plurality of input key units, and, hereafter, the division value will not be further explained.

### BRIEF DESCRIPTION OF DRAWINGS

Further objects and advantages of the invention can be more fully understood from the following detailed description taken in conjunction with the accompanying drawings, in which:

FIG. 1 is a conceptual view showing a data input apparatus for a handheld terminal according to the invention;

FIG. 2 is a perspective view showing the bottom face of a sliding panel in FIG. 1;

FIG. 3 is an exploded perspective view showing an input module according to the invention;

FIG. 4 is a cross-sectional view taken along the line A-A showing the input module in FIG. 3 coupled completely;

FIG. 5 shows an example of the input module in FIG. 3 resting on the handheld terminal;

FIG. 6 is a perspective view showing another example of a data input apparatus for a handheld terminal according to the invention;

FIG. 7 shows data input principles according to the invention;

FIG. 8 shows data input principles of a modified example of FIG. 7;

FIG. 9 shows an example of key values corresponding to a plurality of input keys in a method of inputting data according to the invention;

FIG. 10 is a perspective view showing an input apparatus combined with the handheld terminal in one set according to the invention;

FIG. 11 is a plain view showing an example of using status of FIG. 10;

FIG. 12 shows a system block diagram of the input apparatus according to the invention;

FIG. 13 is a perspective view showing a modified example of FIG. 10;

FIG. 14 is a perspective view showing another modified example of FIG. 10;

FIG. 15 is a perspective view showing the other modified example of FIG. 10;

FIG. 16 is a perspective view showing the input apparatus configured as an independent object according to the invention; and

FIG. 17 is a perspective view showing the input apparatus of FIG. 16 coupled and connected to a general handheld terminal.

### BEST MODE FOR CARRYING OUT THE INVENTION

The preferred embodiments of the present invention will be hereafter described in detail with reference to the accompanying drawings.

### First Embodiment

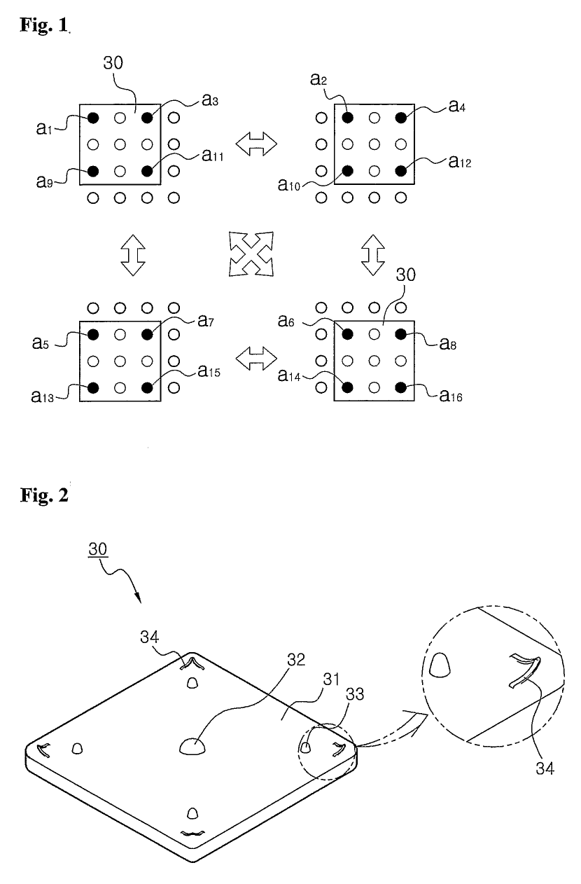

FIG. 1 is a conceptual view showing a data input apparatus for a handheld terminal according to the invention, and FIG. 2 is a perspective view showing the bottom face of a sliding panel 30 in FIG. 1.

In FIGS. 1 and 2, sixteen input points a1-a16 on a touch screen configure a screen output, and a sliding panel 30 having an area which covers nine input points among the sixteen input points is provided.

Here, the sliding panel 30 includes a square panel 31 and four input members 33 protruding in the directions of the left upper corner side, left lower corner side, right upper corner side, and right lower corner side at the bottom surface of the panel 31, which are corresponding to four points of the input points. An elastic member 34 having desired elastic stability is provided on the surface neighboring with the input member 33, and a brace prominence 32 protruding downwardly more than the input member 33 is provided at the center portion of the bottom surface of the panel 31. (refer to FIG. 2)

Accordingly, as shown in FIG. 1, the principle of operation is such that, since the sixteen input points a1-a16 are aligned with all the input members 33 by the four displacement actions of the sliding panel 30, corresponding data is entered through a corresponding input point by aligning an input key value to be entered with a corresponding input point and then applying a certain pressure on the top surface of the corresponding input member 33.

At this point, the sixteen input points a1-a16 forming screen output on the touch screen are displayed as input keys such as a general character, a figure, a symbol, a number, or the like, and/or a function selection key. When applying pressure to a function selection key or a specific input key for a certain time using the sliding panel 30, the mode is changed to the well-known commonly used “character transition mode” such as English capital letter/English small letter/Japanese Hiragana/Japanese Katakana/Korean consonant/Korean vowel/number/figure/symbol, etc., and thus a corresponding character is selected and entered, so that various characters are entered by the sixteen input points.

Here, the input member is embodied in a prominence having the same material as the touch pen described above, or embodied in a non-contacting method such as a discharging element and/or a magnet using the electric contact point principle and/or the magnetism detecting principle, and can be formed on a certain surface of the sliding panel 30 described above or inserted inside the sliding panel.

Preferably, the sliding panel 30 is embodied selecting from the materials having one or more functions of a light-transmitting material, a semi light-transmitting material, or a transparent material, so that a corresponding input key configuring the screen output from the touch screen of the handheld terminal through the sliding panel 30 is identified and recognized.

### Second Embodiment

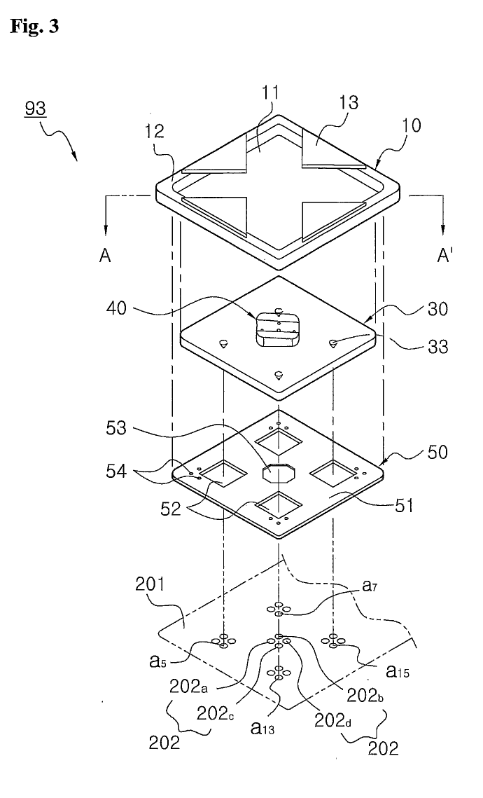

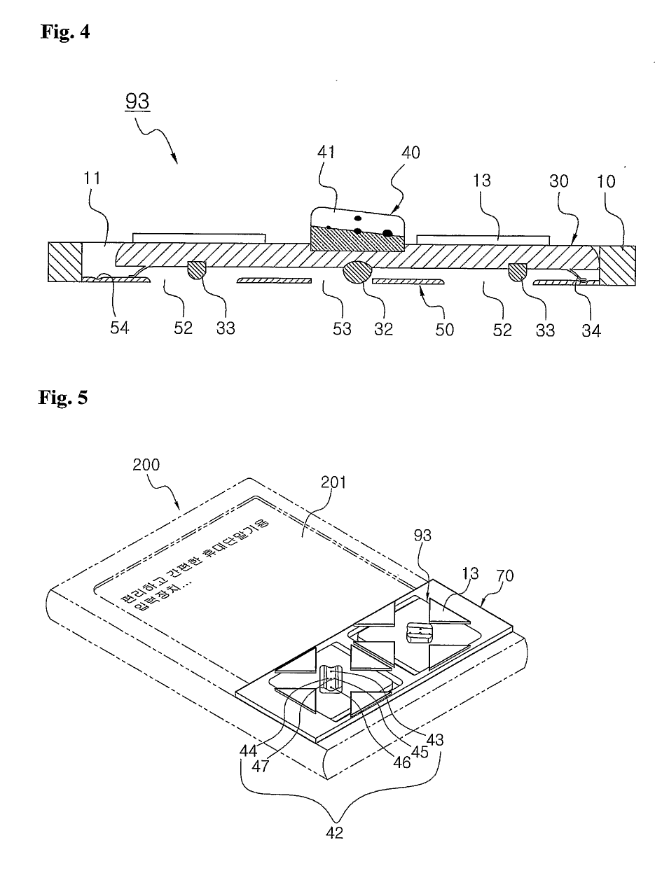

FIG. 3 is an exploded perspective view showing an input module 93 according to the invention, FIG. 4 is a cross-sectional view taken along the line A-A showing the input module 93 in FIG. 3 coupled completely, and FIG. 5 shows an example of the input module 93 in FIG. 3 resting on a handheld terminal 200. The figures illustrate the configuration more specifically and practically than the first embodiment described above.

According to FIG. 3 to 5, an input module 93 including a sliding panel 30 can be used individually as shown in the first embodiment described above, and can be used together with a frame 70, in which two coupling holes (the figure number is not shown) having an inner diameter of the same size and shape as the outer diameter of the input module 93 are provided so that the input module 93 is inserted into each combining hole. (refer to FIG. 5)

The input module 93, looking into more specifically referring to FIG. 3, having the same configuration as the sliding panel 30 of the first embodiment forms of a finger resting member 40 at the center portion of the top surface in the diagonal direction so as the thumb of a user can be rested on. (refer to FIG. 5)

More specifically, the finger resting member 40 includes a finger rest 41 of a U shape groove, on the end portion of which a thumb or the like rests, and a pressurizing prominence 42 having a plurality of prominences on the same surface as the finger rest 41, in which a base prominence 47 protruding at the center portion of the surface and pressurizing prominences 43, 44, 45, 46 protruding in the front and rear, and the left and right sides of the base prominence 47 are provided. The principle of the operation is such that the pressurizing action applied on the input members 33 is performed by applying pressure on the pressurizing prominences 43, 44, 45, 46 selectively using the thumb or the like described above, the input members being provided in the direction of the left upper corner side, the left lower corner side, the right upper corner side, and the right lower corner side, so that a corresponding input member 33 moves down centering around the brace prominence as a pivoting point and contacts with a corresponding input key. Therefore, the input operation can be performed easily with only a little energy and action as described above.

On the other hand, a top panel 10 having a hollow 11 is provided, the top panel having the same shape and longer inner diameter than that of the sliding panel 30 so as to be moved to the up, down, left, and right side of the sliding panel 30. A plurality of detachment protecting latches 13 extended toward the side in a certain shape are formed at the top surface rim 12 side of the top panel 10 so as to prevent the detachment of the sliding panel 30. The coupling principle is such that the sliding panel 30 is inserted inside the hollow 11.

At this point, at the bottom surface of the top panel 10 which accepts the sliding panel 30, a guide panel 50 is provided, the guide panel having the same or smaller area than the top panel 10 and having a bigger area than the sliding panel 30. Here, a panel 51 which practically forms the guide panel 50 includes an input through-hole 52 and a location contact point through-hole 53 which are as large as to allow the brace prominence 32 and the input members 33 to be protruded downwardly, even though they are displaced when the sliding panel 30 moves inside the hollow 11. The portions corresponding to the center portion and the input members 33 pass through the input through-hole 52 and the location contact point through-hole 53. A location alignment depression 54 is multiply formed on the rim of the top surface of the panel 51, the location alignment depression for recognizing by the sense of touch that a point end (the figure number is not shown) of an elastic member 34 formed on the sliding panel 30 is inserted in the depression and the input member 33 is aligned with the input point of the touch screen 201.

Therefore, it is understood that the input point which forms the screen output through the touch screen 201 can be configured densely in fours according to the size of the hollow 11 as shown in FIG. 3. It is also understood that a location contact point 202 which embodies the completion of location alignment for performing practical input operation in a pressure applying contact point is configured. The location alignment is completed by contacting the touch screen 201 and the brace prominence 32 each other.

Describing the principle of operation more specifically, even though pressure is applied to a specific input point of the touch screen 201 using the input module 93 while the location alignment input signal is not detected through the location contact point 202, a handheld terminal is set so as not to recognize the pressure, therefore an input error can be prevented when the location alignment is not established properly.

### Third Embodiment

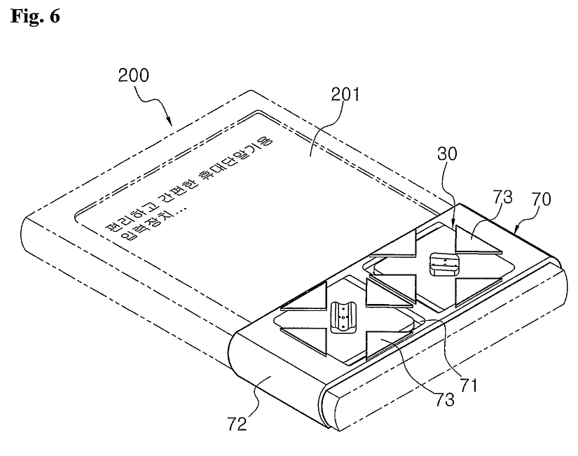

FIG. 6 is a perspective view showing another example of a data input apparatus for a handheld terminal according to the invention, that is, a configuration of using the sliding panel 30 of the first embodiment and the frame 70 of the second embodiment described above, which can accomplish the same effects as the second embodiment only with further simplified constituents.

More specifically, a lattice 72 or a double lattice (not shown) is formed on the side surface of the frame 70 in order to be forcibly inserted and coupled so as to hold a certain portion of a handheld terminal 200, or the data input apparatus is configured so as to be fixed to the handheld terminal 200 by a coupling method such as a slide coupling. In addition, the frame 70 includes two sliding through-holes 71 having the same inner diameter as that of the hollow 11 explained in the second embodiment described above, and the detachment preventing latch 73 described above is multiply formed on the surface of the sliding through-hole 71.

The coupling method is configured such that, while the sliding panel 30 is inserted in the sliding through-hole 71 and can perform a sliding displacement, the detachment prevention of the sliding panel 30 can be realized by the detachment preventing latch 73.

### Fourth Embodiment

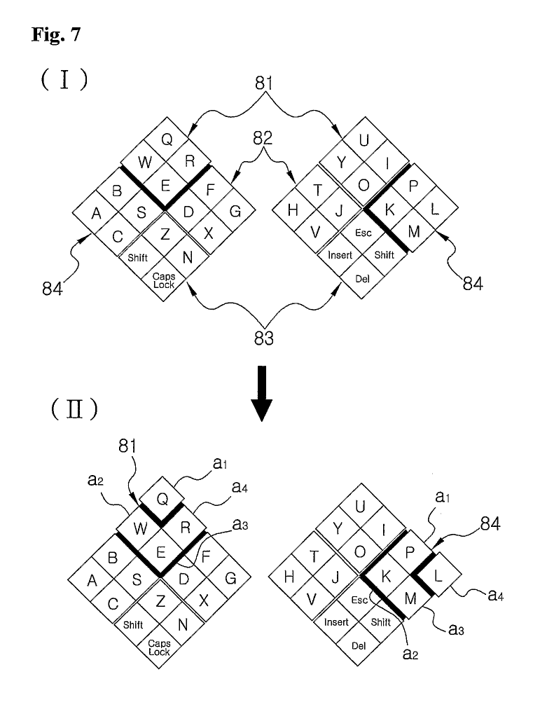

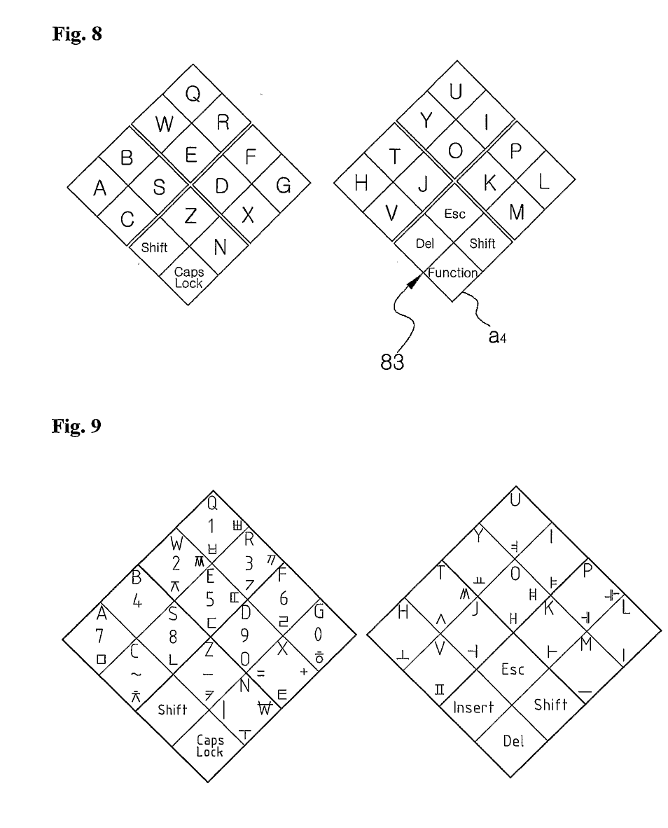

FIG. 7 shows data input principles according to the invention, and FIG. 9 shows an example of key values corresponding to a plurality of input keys in a method of inputting data according to the invention.

Referring to FIG. 7, four input key units 81, 82, 83, 84 and four input keys a1, a2, a3, a4 in each input key unit 81, 82, 83, 84 are provided, so that a key input unit (not shown) formed of sixteen input keys configures two screen outputs on the display unit 120 of the handheld terminal 200.

As shown in (I), an input key unit 81, 84 which has its own division value is selected respectively using two input members 131 described below, and thus the input key unit selection step in which a corresponding division value is entered is processed. Thereafter, according to re-manipulation of the two input members 131, an input key a1, a4 provided to the selected input key unit is selected respectively as shown in (II), so that the corresponding key value is entered in the handheld terminal 200 and displayed on the display unit 120.

Here, a separate function key is not shown, however, when two input members establish a simultaneous contact point with a certain input contact points (for example, in the case where all the two input members establish simultaneous contacting points with the input contact points which are located in the left and right direction) within a certain time (for example, 0.5 seconds) respectively, the mode is changed to the well-known commonly used “character transition mode” such as English capital letter/English small letter/Japanese Hiragana/Japanese Katakana/Korean consonant/Korean vowel/number/figure/symbol, etc., or to the “function selection mode” for selecting a function such as an internet searching, a system mode, a schedule mode, and the input mode described above, so that the fiction selection as well as the input operation of various character information can be embodied easily. The input mode is preferably configured so as to be concurrently performed in a specific mode which is selected by the function selection mode, so that character information can be entered while performing a specific mode such as the internet searching.

Accordingly, using the two key input units (not shown) and the same number of related input members 121, a method of inputting data having a 4-way contact point method, i.e., up, down, left, and right, can be provided. The contact point method allows speedy and correct data input to be performed easily, like a general keyboard.

Preferably, as shown in FIG. 9, in arranging the key values correspond to the thirty two input keys, it is desirable to allocate in the same or similar way to the character arrangement of a general keyboard, which is familiar to a user.

### Fifth Embodiment

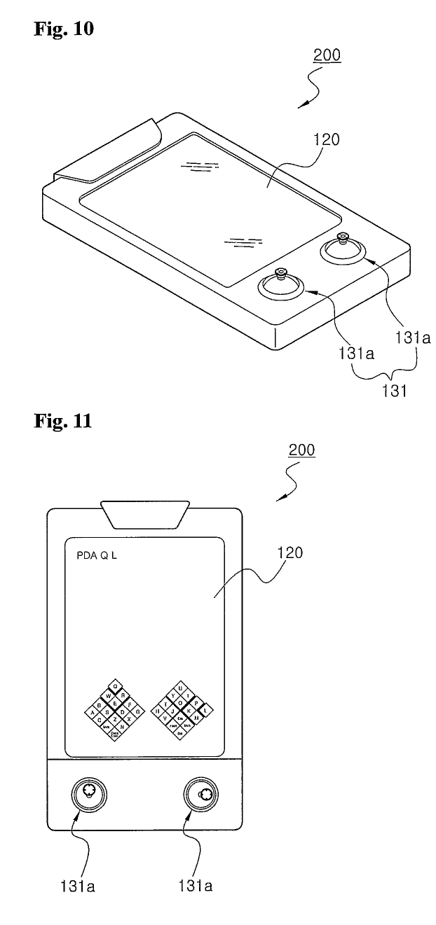

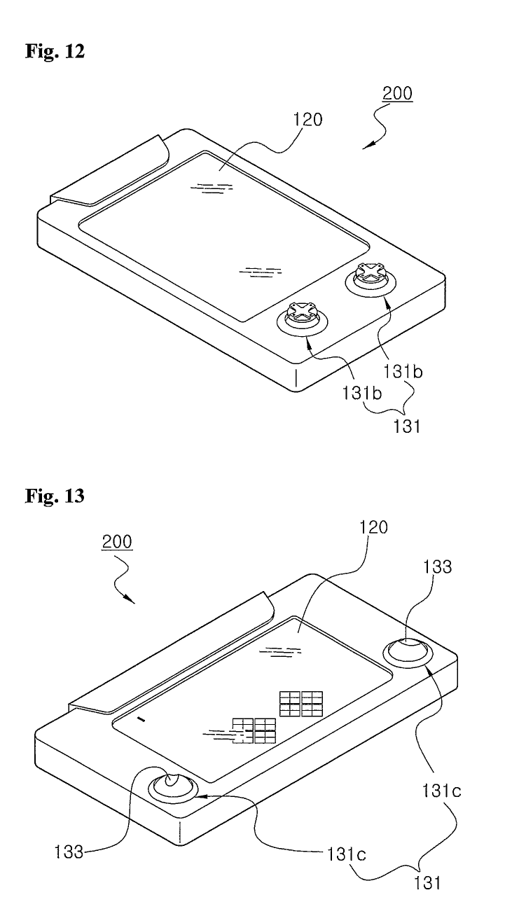

FIG. 10 is a perspective view showing an input apparatus combined with the handheld terminal in one set according to the invention, FIG. 11 is a plain view showing an example of using status of FIG. 10, and FIG. 12 shows a system block diagram of the input apparatus according to the invention. The figures illustrate a specific configuration for embodying the input principle described above.

In FIGS. 10 and 11 with reference to FIG. 12, a handheld terminal 200 comprises a display unit 120, a character data 111 where various character information is stored, an input member 131 embodied by two input levers 131a, and an input control means 90 including a controller 100.

More specifically, the input lever 131a manufactured in the same form as a general joystick is preferably formed to have a shorter lever, so that, when a user handles the input lever 131a while holding the handheld terminal 200, feeling of fatigue at the hand can be lessened.

At this point, the handheld terminal 200 is provided with four input contact points (not shown) which establish electric contact points with the input lever 131a and sends a corresponding signal to the controller 100 when the input lever 131a establishes a contact point with the input contact point. Accordingly, the input lever 131a contacts with an input contact point located at a corresponding portion only when the input lever is displaced in the four directions described above.

On the other hand, the input control means 90, as shown in FIG. 12, includes a screen output module 91, an input key unit selection module 92, an input module 93, a communication module 94, and a controller 100 which is electrically connected to the above modules and controls generally.

More specifically, first, as a control method for embodying the input method according to the fourth embodiment, the screen output module 91 outputs the corresponding key value stored in the character data 111 to the lower portion 45 of the display unit 120 in a form of a 4×4 input key according to the command of the controller 100.

Then, if the controller 100 receives a corresponding signal generated by the manipulation of the input lever 131a, the input key unit selection module 92 is controlled by the command of the controller 100 so as to select the input key unit corresponding to the received signal, and displays the input key unit selected through the display unit 120 using an appropriate screen out method so that a user can recognize the input key unit.

Therefore, if the controller 100 receives again a corresponding signal generated by the re-manipulation of the input lever 131a, the input module 93, by the command of the controller 100, retrieves the corresponding key value of the input key corresponding to the signal from the character data 111, i.e., an input key among the input keys contained in the selected input key unit, outputs to the upper portion 46 of the display unit 120, and feeds back to the input key unit selection step described above.

Accordingly, if the input lever 131a is displaced first in each predetermined direction, an input key unit corresponding to the direction is selected. When the input lever is displaced second, an input key included in the selected input key unit is entered, and, at the same time, the operation is fed back to the input key unit selection step. Therefore, the desired data can be entered efficiently, fast, and correctly.

### Sixth Embodiment

FIG. 13 is a perspective view showing a modified example of FIG. 10, which illustrates an embodiment of the input member 131 in a general 4-way input button 131b.

Therefore, a handheld terminal 200 designed more compactly can be embodied, and, since a user is familiar with the input type, it can be easily used.

### Seventh Embodiment

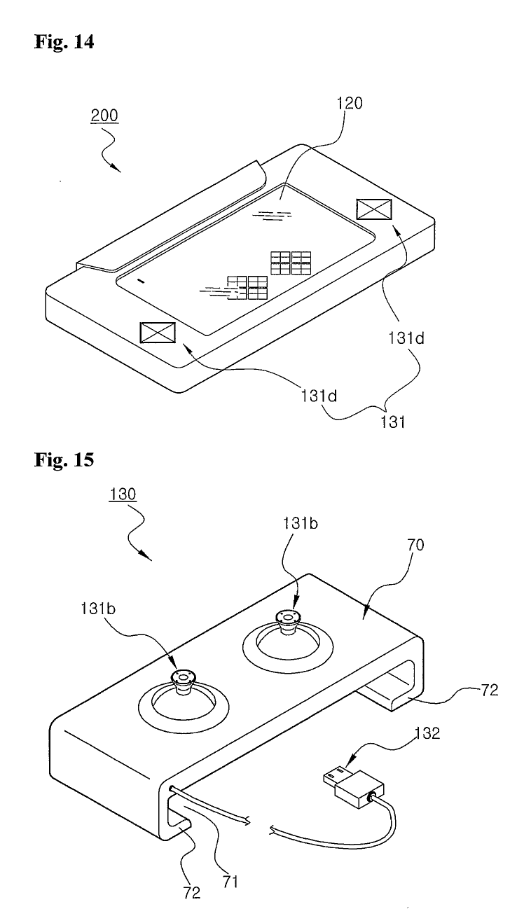

FIG. 14 is a perspective view showing another modified example of FIG. 10, which illustrates a 4-way input button 131c. When configuring an input member 131, the input lever 131a described above is omitted, and, on the surface where the input lever is placed, a finger resting depression 133 of a shape allowing a thumb or the like to be rest is provided.

### Eighth Embodiment

FIG. 15 is a perspective view showing the other modified example of FIG. 10, which describes an input member 131 embodied in a diamond or a rectangular shape input button 131d. It shows an example of a configuration, in which the center portion of the input button 131d protrudes upwardly so as a thumb or the like may rest on the button, so that the input operation is easy and the input button 131d can be recognized by the sense of touch.

### Ninth Embodiment

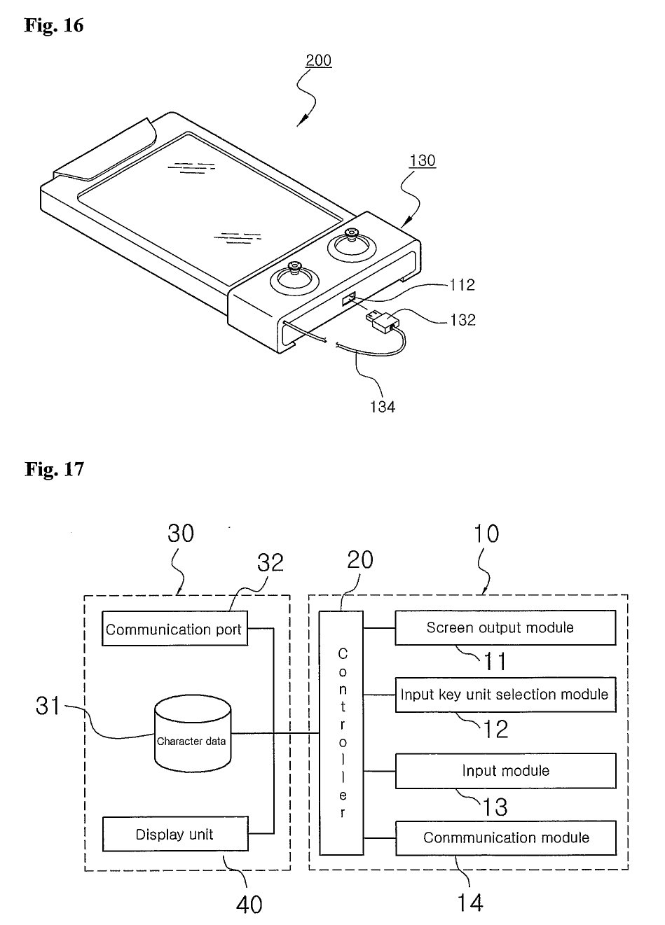

FIG. 16 is a perspective view showing the input means 130 configured as an independent object according to the invention, and FIG. 17 is a perspective view showing the input means 130 of FIG. 16 coupled and connected to a general handheld terminal 200. The figures show an example which can be applied to an existing handheld terminal 200.

In FIG. 16, the input means 130 includes a housing 70, an input member 131 embodied in an input lever 131a of the fifth embodiment on the housing 70, a lattice 72 for slide coupling the input means to a certain portion of a handheld 200, the lattice being the downward extension of both sides of the housing, a sliding through-hole 71 formed between the lattice 72 and the bottom surface of the housing 70, and a cable 134 projected from a certain portion of the housing 70 and provided with a connection terminal 132 such as a USB terminal at the end portion.

In FIG. 17 with reference to FIG. 12, the cable 134 of the input means 130 is connected to a circuit board containing a controller 100 such as a microcomputer inside the housing 70, and the modules 91, 92, 93 of the fifth embodiment described above are provided. In addition, a corresponding signal generated by the input means 130 is transmitted to the handheld terminal 200 through the connection terminal 132 and a communication port 112 of the handheld terminal 200, and thus character information corresponding to the signal is retrieved from the character data 111 and displayed. Needless to say, being connected to the input means 130 for communication, the handheld terminal 200 is installed with a software for outputting a 4×4 type input key, and the software can be installed by a user or an appropriate A/S center, so that data input is accomplished.

### INDUSTRIAL APPLICABILITY

As described above, using a data input apparatus according to the invention, input operation can be performed easily and fast using both hands instead of a touch pen, and maximum four characters can be entered by one displacement action of a sliding panel, and, a finger resting member being provided, displacement action of the sliding panel and pressurizing action of a corresponding input key can be performed easily.

In addition, only in the case where a specific portion of a touch screen establishes a location contact point with a brace prominence, and an input point is established by the pressurizing action of a target input point and an input member, a corresponding data is entered, so that input errors can be prevented fundamentally.

In addition, using diverse input means as well as four direction keys formed in a general keyboard, diverse character information can be entered into the terminal fast, correctly, and easily.

Also, while holding a handheld terminal, an input operation can be performed conveniently, and an electronic input output system can be embodied so as to prevent the display unit from being damaged. Needless to say, using various input members, desired data can be entered easily.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A data input apparatus for a handheld terminal, the apparatus comprising:
a sliding panel including a panel of a certain shape and a plurality of input members arranged at regular intervals on a certain portion of the bottom face of the panel; and
a frame having the same shape as the sliding panel, the frame including one or more sliding through-holes having a longer inner diameter than that of the sliding panel, resting on a plurality of input buttons contained in the handheld terminal or on a plurality of input points forming a screen output from a touch screen, and inputting a key value of a corresponding input point by aligning any one of the input buttons or the input points with any one of the input members, the alignment being established by inserting the sliding panel into the sliding through-hole and displacing in a sliding manner.

2. The data input apparatus according to claim 1, wherein the sliding panel is formed in a square shape, further includes a brace prominence protruding at the center portion of the bottom surface, and has the input members allocated by one at each corner respectively,
the four input members being aligned with any one of the four input points among the sixteen input points, the four input points being located at the place where the sliding panel is displaced inside the sliding through-hole according to four displacement methods of each corner, thereby entering the key value of a corresponding input point.

3. The data input apparatus according to claim 1, further comprising one or more of:
a guide panel including a location contact point through-hole and one or more input through-holes, wherein a portion of the surface corresponding to the brace prominence and a plurality of the input members pass through thereof according to the displacement of the sliding panel, and covers the bottom surface of the sliding through-hole;
one or more detachment preventing latches, the latch being the top surface of the frame neighboring with the sliding through-hole extended to the direction of the sliding through-hole in a certain shape;
and a coupler coupling the handheld terminal to both sides of the frame.

4. The data input apparatus according to claim 3, further comprising:
an elastic member including a point end, the elastic member being provided on the surface neighboring with the input member; and a location alignment depression formed of one or more depressions, thereby the point end being latched and supported while an input member of the sliding panel is aligned with a corresponding input point.

5. The data input apparatus according to claim 3, wherein the touch screen is configured such that, while the sliding panel is displaced and the input point is aligned with the input member, a location contact point is provided at each portion of the surface corresponding to the brace prominence, and only when the brace prominence and the location contact point establish a contacting point, the corresponding key value of the desired input point is entered.

6. A data input apparatus further comprising an input control means, wherein, in the data input apparatus including a plurality of input contact points, an input means having one or more input members selected from an input lever or an input button, the input lever or the input button establishing a contact point with the input contact point, and a terminal having a display unit, a communication port, and a character data such as character/symbol/image/number information,
the input control means includes a screen output module loaded in the terminal or the input means for outputting a plurality of input key units in a divided form respectively through the display unit, the input key unit containing a plurality of input keys;
an input key unit selection module for selecting a corresponding input key unit when an input member re-establishes a contact point with any one of the input contact points; and
an input module for retrieving the corresponding key value of the input key from the character data and outputting on the screen through the display unit, when the input member re-establishes a contact point with any one of the input contact points again, and, at the same time, changing to the initial mode for selecting the input unit.

7. The data input apparatus according to claim 6, wherein the input control means changes the mode from a character transition mode/enter key/function mode/selection mode to one or more modes, when a plurality of the input members establish a simultaneous contacting point.

8. A method of inputting data into a handheld terminal, wherein a sliding panel provided with four input members is displaced to four directions of each corner, and any one of the four input members contained in the sliding panel is aligned with a corresponding input point of an input button or a touch screen, and thus the key value of the aligned input point is entered.

9. The method according to claim 8, wherein the sliding panel is displaced and a corresponding input point is aligned with any one of the four input members, and a brace prominence protruded on the bottom surface of the sliding panel and a location contact point which confirms the location of the sliding panel establish a contact point each other, and thus the key value of the corresponding input point is entered.

10. A method of inputting data into a handheld terminal, the method comprising steps of:
i) selecting an input key unit containing a desired input key value to be entered from a plurality of input key units by manipulating an input member of an input means, the input key unit containing a division value and a plurality of input keys; and
ii) inputting the desired input key value by re-manipulating the input member and selecting one input key from a plurality of the input keys having the same division value.

11. The method according to claim 10, wherein four input key units are formed, wherein each input key has a division value of one of four divisions, thereby providing 4×4 number of input keys.

12. The method according to claim 10, wherein, when inputting a division value through the input member at the same time or within a certain time period, a key value of a function mode is entered.
